(19) United States
(12) Patent Application Publication
(10) Pub. No.: US 2022/0123330 A1
(43) Pub. Date: Apr. 21, 2022

(54) FUEL CELL GASKET

(71) Applicants: NOK CORPORATION, Tokyo (JP); Honda Motor Co., Ltd., Tokyo (JP)

(72) Inventors: Toshihiro SHIMAZOE, Kikugawa (JP); Shuhei GOTO, Wako (JP)

(21) Appl. No.: 17/428,077

(22) PCT Filed: Jan. 9, 2020
(86) PCT No.: PCT/JP2020/000514

§ 371 Date: Aug. 3, 2021

(30) Foreign Application Priority Data
Mar. 28, 2019 (JP) 2019-062806

(51) Int. Cl. H01M 8/0276; H01M 8/0282

(52) U.S. Cl. CPC H01M 8/0276; H01M 8/0282

(57) ABSTRACT

A bipolar plate is provided that prevents pressure leaks from occurring at a seal bead. A fuel battery gasket is provided. The gasket is structured to include a pair of metal-made bipolar plates, seal beads, and a tunnel. The bipolar plates are interposed between a plurality of reaction electrode portions. The bipolar plates are fastened together with the reaction electrode portions and thereby joined to each other. The seal beads are provided at one or both of the bipolar plates by being patterned in full-bead forms. The tunnel is bridged between the adjacent seal beads and allows their insides to communicate with each other. When a height of the seal bead is H1 and a height of the tunnel is H2, H1/H2 is set to be equal to or larger than 1.6.

### CROSS REFERENCE TO RELATED APPLICATIONS

This application is a U.S. National Phase Application under 35 U.S.C. 371 of International Application No. PCT/JP2020/000514, filed on Jan. 9, 2020, which claims priority to Japanese Patent Application No. 2019-062806, filed on Mar. 28, 2019. The entire disclosures of the above applications are expressly incorporated by reference herein.

### BACKGROUND

### Technical Field

The present invention relates to a fuel battery gasket formed by seal beads. The seal beads are provided at a pair of metal-made bipolar plates. A pair of the bipolar plates are interposed between a plurality of reaction electrode portions and joined to each other.

### Related Art

One of conventional structures of a fuel battery is a stack structure including a plurality of fuel cells stacked over each other. The fuel cell includes a reaction electrode portion (MEA) and a pair of bipolar plates. The reaction electrode portion includes an electrolyte film and a pair of electrode layers provided on both surfaces of the electrolyte film. A pair of the bipolar plates are layered on both thickness-direction sides of the reaction electrode portion. According to this type of fuel battery, an oxidation gas (air) is supplied to a cathode side in the reaction electrode portion, and a fuel gas (hydrogen) is supplied to an anode side in the reaction electrode portion. The fuel battery thereby generates electric power by electrochemical reaction that is reverse reaction of electrolysis of water.

Flow paths for media such as an oxidation gas (air), a fuel gas (hydrogen), and cooling water are provided inside the stacked fuel cells. Such flow paths are formed by the bipolar plates, for example. The bipolar plates are a pair of plate-shaped members made of a metal material such as iron or aluminum and joined to each other. The flow paths for the media are formed between a pair of these members and between these member and other members.

Japanese Patent No. 4959190 (hereinafter, referred to as Patent Literature 1), for example, describes a fuel battery fabricated as follows. A reaction electrode portion and gas diffusion layers (referred to as “gas dispersion layer” in Patent Literature 1) are sandwiched between a pair of bipolar plates so that a fuel cell is configured. A plurality of such fuel cells are stacked over each other and fastened to each other so that the fuel battery is fabricated.

The fuel cells adjacent to each other are layered over each other. The bipolar plates are in this manner joined to each other, because of the structure in which the reaction electrode portion and the gas diffusion layers are sandwiched between a pair of the bipolar plates. Each of the two bipolar plates joined to each other includes a seal bead having a full-bead form, as illustrated in FIG. 5b and FIG. 6b, for example. The two bipolar plates are joined to each other such that positions of their seal beads are matched. Thereby, a cavity is formed inside the seal beads facing each other. Spaces inside and outside the cavity are used as flow paths for flowing of media such as H2 and water.

Patent Literature 1 discloses two manifolds (refer to FIG. 4 in Patent Literature 1). These manifolds are used as flow paths for a reactant and a coolant. The bipolar plates seal, with the seal beads, areas surrounding the manifolds. The bipolar plate forms a bead arrangement at a position corresponding to the reaction electrode portion that forms an electrochemically active region.

One of the manifolds is surrounded by the seal bead having the full-bead form, as illustrated in FIG. 5b of Patent Literature 1. This seal bead serves to supply the medium such as H2 or water to the reaction electrode portion (refer to the paragraph in Patent Literature 1).

More specifically, the two seal beads surrounding the one of the manifolds form cavities inside. One of these two seal beads is provided with hole-like perforations (refer to FIG. 5b in Patent Literature 1). This enables the medium to be supplied in the direction of the arrows drawn in FIG. 5a and FIG. 5b of Patent Literature 1, i.e., supplied from an outside of the cavity into the cavity through the perforations and then from the cavity to an outside of the cavity through the opposite perforations (refer to the paragraph in Patent Literature 1).

The other manifold is used for providing a cooling-water flow to the gap between the two bipolar plates joined to each other, as illustrated in FIG. 6b of Patent Literature 1. The other manifold is surrounded by the seal bead having the full-bead form, as illustrated in FIG. 6b of Patent Literature 1. This seal bead serves to allow the cooling water to flow (refer to the paragraph [0055] in Patent Literature 1).

More specifically, the two seal beads surrounding the other manifold form cavities inside. One of these two seal beads is provided with hole-like perforations at positions facing the manifold. The seal beads adjacent to each other are connected to each other via a tunnel (refer to FIG. 6b in Patent Literature 1). Such a structure allows the supplied cooling water from the manifold to flow into the first cavity via the perforations and to be supplied from this cavity to the next cavity via the tunnel (refer to the paragraph [0062] in Literature 1).

When a fuel battery is fabricated by stacking fuel cells over each other, a pressure leak sometimes occurs at a seal bead provided at a bipolar plate. This phenomenon is one in which pressure received by the seal bead is partially insufficient. The phenomenon causes a leak of a medium such as a reaction medium or cooling water. Thus, the phenomenon is desired to be reliably prevented.

The inventors of this application searched for a cause of the pressure leak occurring at the seal bead, and found that presence or absence of a tunnel is related as one factor. In other words, the seal beads around the manifolds includes, as illustrated in FIG. 5a and FIG. 6a of Patent Literature 1, the seal bead without the tunnel (refer to FIG. 5a in Patent Literature 1) and the seal bead with the tunnel (refer to FIG. 6a in Patent Literature 1). Comparing these two types of seal beads makes it found that a characteristic of reaction force at the time of compression differs depending on presence or absence of the tunnel.

More specifically, a linear load is lower in the seal bead with a tunnel than in the seal bead without the tunnel. This causes a decline in linear load. It is inferred that a pressure leak occurring at the seal bead is caused by such a decline in linear load.

An object of the present invention is to prevent a pressure leak from occurring at a seal bead provided at a bipolar plate.

### SUMMARY

A fuel battery gasket according to the present invention includes: a pair of bipolar plates made of metal, interposed between a plurality of reaction electrode portions, and fastened together with the reaction electrode portions so as to be joined to each other; seal beads provided at one or both of the bipolar plates; and a tunnel bridged between the adjacent seal beads and allowing insides of the adjacent seal beads to communicate with each other; wherein when a height of the seal bead is H1 and a height of the tunnel is H2, H1/H2 is set to be equal to or larger than 1.6.

### Advantageous Effects

According to the present invention, a decline in linear load generated at the seal bead can be suppressed. Thus, a pressure leak can be prevented from occurring at the seal bead provided at the bipolar plate.

### BRIEF DESCRIPTION OF THE DRAWINGS

FIG. 1 is a perspective view of a part of a bipolar plate, which illustrates one embodiment.

FIG. 2 is a plan view of the embodiment.

FIG. 3 is a cross-sectional view taken along the line A-A in FIG. 2.

FIG. 4 is a cross-sectional view taken along the line B-B in FIG. 2.

FIG. 5 is a graph representing a relation between a ratio of a tunnel height to a bead height and a linear load generated at the bead.

### DETAILED DESCRIPTION

The present embodiment relates to a fuel battery gasket that belongs to bipolar plates. The bipolar plate is used in a fuel cell constituting a fuel battery.

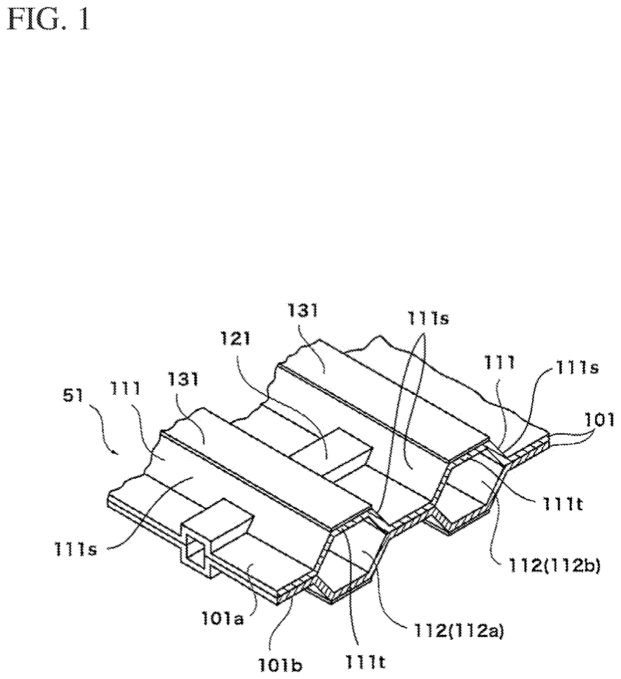

The fuel battery gasket 51 of the present embodiment is formed by seal beads 111 formed at the bipolar plates 101, as illustrated in FIG. 1. The one bipolar plate 101a in FIG. 1 is one of a pair of bipolar plates that form a fuel cell. The other bipolar plate 101b in FIG. 1 is one of a pair of bipolar plates that form another fuel cell adjacent to the fuel cell. These bipolar plates 101a and 101b are joined to each other, and form a cavity 112 at a part where the seal beads 111 face each other. The seal beads 111 each have a full-bead form. The cavity 112 positioned on the left side in FIG. 1 is referred to also as a cavity 112a. The cavity 112 positioned on the right side in FIG. 1 is referred to also as a cavity 112b. The seal beads 111 are formed at the bipolar plates 101a and 101b by being patterned.

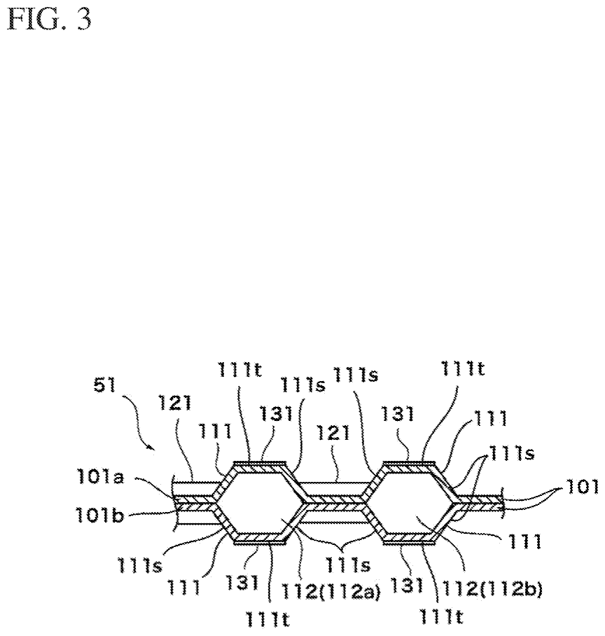

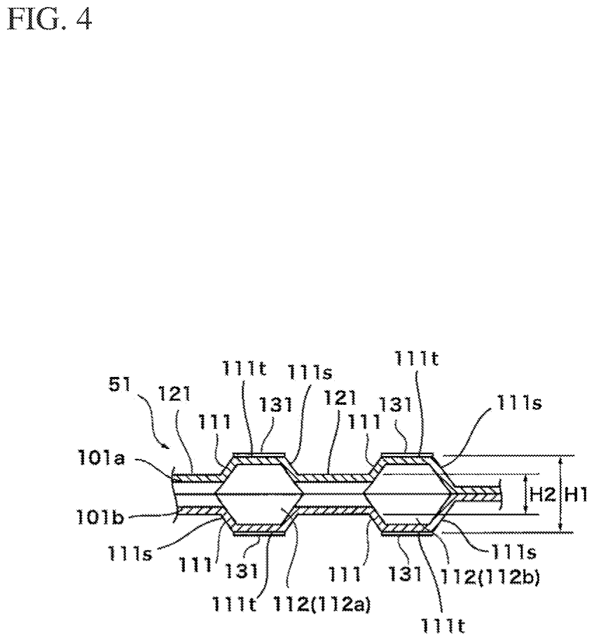

The seal bead 111 is shaped so as to include, as one example, a top portion 111t and inclined side walls 111s connected to both ends of the top portion 111t. The side wall 111s is inclined so as to have a shape of standing, at an obtuse angle, from a base portion of the bipolar plate 101. The top portion 111t looks flat at a glance as illustrated in FIG. 1, FIG. 3, and FIG. 4, but is actually formed so as to include a curved surface that is slightly curved upward. A curvature of the curved surface can be appropriately set concerning a shape of the curved surface of the top portion 111t. As the curvature is larger, the curved surface is closer to a flat surface. As the curvature is smaller, the curved-surface shape is emphasized. However, the seal bead 111 is not limited to such a shape when actually implemented, and may have any of various shapes. For example, the seal bead 111 is allowed to have a polygonal shape such as a pentagon.

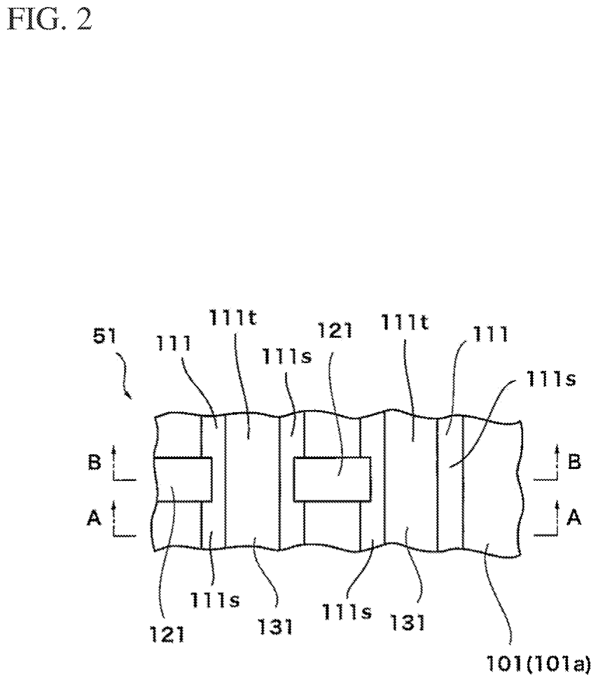

A tunnel 121 is provided between the two seal beads 111 as illustrated in FIG. 1 and FIG. 2. Another tunnel 121 is provided also between the seal bead 111 positioned on the left side and an un-illustrated seal bead 111 positioned on a further left side. The tunnel 121 is connected to the side walls 111s of the two seal beads 111.

The tunnel 121 is formed so as to have a cross-sectional shape of a rectangle as one example. However, the tunnel 121 is not limited to such a shape when actually implemented, and may have any of various shapes such as a cross-sectional shape of a trapezoid and a shape that partially includes a curved surface.

The two bipolar plates 101a and 101b make complete surface contact with each other, except areas where the seal beads 111 are provided, in a part (the cross section taken along the A-A line in FIG. 2) where no tunnels 121 are provided, as illustrated in FIG. 3. The two bipolar plates 101a and 101b form spaces only at parts that are the cavities 112. Accordingly, the spaces defined as the cavities 112 are sealed from other spaces.

The cavities 112 communicate with each other via the tunnel 121 and the surface contact is not made at an area where the tunnel 121 is provided, in a part (the cross section taken along the B-B line in FIG. 2) where the tunnel 121 is provided, as illustrated in FIG. 4.

The thus-configured fuel battery gasket 51 includes a seal element 131 laminated on a surface of the seal bead 111.

Here, one example used as a material of the bipolar plate 101 is a low-rigidity base material that is a steel plate having a plate thickness of 0.05 to 0.2 mm and having a Vickers hardness equal to or lower than 300. Its preferable examples in use include austenite stainless steel (SUS316L, 310S, 303L, 304L, and 304), ferrite stainless steel (SUS430), nickel and nickel alloys (a Ni—Cu alloy, Hastelloy, and Inconel), and titanium and titanium alloys (α-, β-, and α-β).

A stack-fastening linear load at the time of fastening and stacking a plurality of the fuel cells is in a range from 0.5 to 10 N/mm as an average linear load, for example. This is because a linear load lower than 0.5 N/mm causes a leak due to insufficiency of surface pressure, and conversely, a linear load higher than 10 N/mm causes a leak due to buckling.

Examples used as a material of the seal element 131 include silicon, SIFEL, ethylene-propylene-diene monomer (EPDM) rubber, fluoro rubber (FKM), and polyisobutylene (PIB). Such a seal element 131 is formed on the surface of the seal bead 111 by screen printing so as to have a thickness equal to or smaller than 100 μm.

What is important in the present embodiment is a ratio between a height H1 of the seal bead 111 and a height H2 of the tunnel 121. A value of H1/H2 in the present embodiment is set to be equal to or larger than 1.6, as illustrated in FIG. 4.

The top portion 111t in the seal bead 111 is formed in a curved shape as described above. Accordingly, a height dimension of the top portion 111t is nonuniform. The height H1 of the seal bead 111 mentioned here represents a height dimension of the highest part in the top portion 111t.

The tunnel 121 has the cross section of the rectangular shape. Accordingly, the tunnel 121 includes a top portion formed as a flat surface having a uniform height. Thus, the height H2 of the tunnel is a height of the top portion of the tunnel. However, the tunnel 121 may have any of various shapes when actually implemented, as described above. When the top portion of the tunnel 121 is formed in a shape of a curved surface, the height H2 of the tunnel 121 also represents a height dimension of the highest part in the top portion, similarly to the height H1 of the seal bead 111.

A value of H1/H2 in such a configuration in the present embodiment is set to be equal to or larger than 1.6, concerning a relation between the height H1 of the seal bead 111 and the height H2 of the tunnel 121. Thereby, a decline in linear load generated at the seal bead 111 can be suppressed. Thus, a pressure leak can be prevented from occurring at the seal bead 111.

### Embodied Example

The inventors of the present application fabricated a prototype and repeated experiment while changing a ratio between the height H1 of the seal bead 111 and the height H2 of the tunnel 121, for the purpose of suppressing a decline in linear load generated at the seal bead 111.

A used material of the bipolar plate 101 for the prototype was SUS304L having a plate thickness of 0.1 mm. This was pressed so that the bipolar plate 101 including the seal beads 111 and the tunnel 121 was formed. At this time, the height H1 of the seal bead 111 and the height H2 of the tunnel 121 can be adjusted by a press die. The prototypes that form a combination of six kinds of values of H1/H2 were prepared for the experiment. Specifically, the values of H1/H2 of the prepared prototypes are a value slightly smaller than 1.4, a value of 1.45, a value slightly larger than 1.5, a value of 1.6, and a value slightly smaller than 1.8. The following terms are used for convenience of description.

Prototype 1: H1/H2=a value slightly smaller than 1.4

Prototype 2: H1/H2=1.45

Prototype 3: H1/H2=a value slightly larger than 1.5

Prototype 4: H1/H2=1.6

Prototype 5: H1/H2=a value slightly smaller than 1.8.

A silicon material having a rubber hardness of 50° was used as the seal element 131. This was screen-printed so as to have a thickness of 40 μm and to be thus set as the seal element 131. The same seal element 131 was used for all the prototypes 1 to 5.

Linear loads were confirmed in the experiment, concerning the prototypes that form a combination of the six kinds of H1/H2. Each of the linear loads was one at an intersection portion between the seal bead 111 and the tunnel 121 and was one when the seal bead 111 was compressed with a predetermined load by Autograph. The linear loads were confirmed by pressure-sensitive paper.

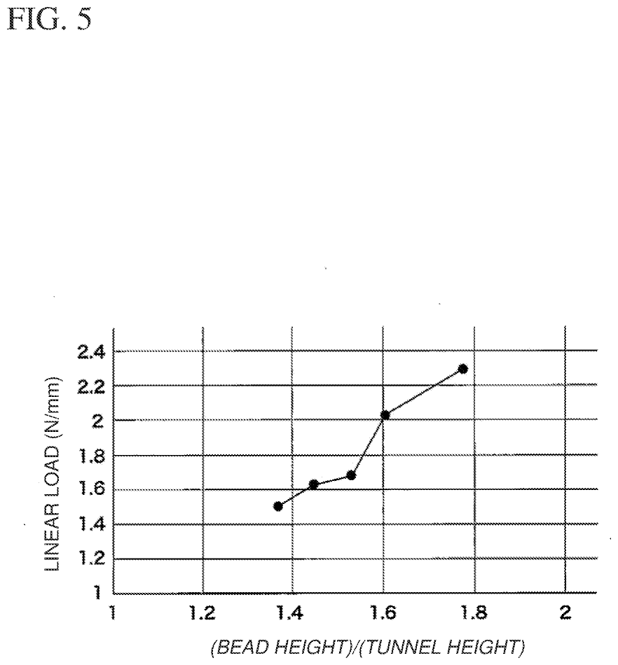

The graph illustrated in FIG. 5 represents results of the experiment. A sharp rise in linear load is recognized between the prototype 3 and the prototype 4 as is clear from this graph. In other words, the linear load of the prototype 1 is approximately 1.5 N/mm, the linear load of the prototype 2 is slightly larger than 1.6, and the linear load of the prototype 3 is approximately a load slightly smaller than 1.7. A large difference between the linear loads is not recognized in a range from the prototype 1 to the prototype 3. In contrast to this, a linear load rises to be slightly larger than 2 N/mm at the prototype 4. In other words, a rise whose amount is equal to or larger than 0.3 N/mm is recognized in relation to the prototype 3.

It can be understood from the above-described results of the experiment that the prototypes 4 and 5 are desirable. In other words, these are the prototypes having, as H1/H2, a value of 1.6 and a value slightly smaller than 1.8. According to the present embodiment, the respective portions are set, based on such verification, in a dimensional relation where H1/H2 is equal to or larger than 1.6, concerning a relation between the height H1 of the seal bead 111 and the height H2 of the tunnel 121. This can suppress a decline in linear load generated at the seal bead 111, and can prevent a pressure leak from occurring at the seal bead 111.

Various modifications and alterations other than those described above are allowed in actual implementation. For example, the seal beads 111 may be formed at only one of the bipolar plates 101a and 101b, instead of being formed at each of the bipolar plates 101a and 101b. Any other modifications and alterations can be made.

1. A fuel battery gasket comprising:
a pair of bipolar plates made of metal, interposed between a plurality of reaction electrode portions, and fastened together with the reaction electrode portions so as to be joined to each other;
seal beads provided at one or both of the bipolar plates; and
a tunnel bridged between the adjacent seal beads and allowing insides of the adjacent seal beads to communicate with each other,
wherein when a height of the seal bead is H1 and a height of the tunnel is H2, H1/H2 is set to be equal to or larger than 1.6.

2. The fuel battery gasket according to claim 1, wherein the bipolar plate is formed of a material that is one of austenite stainless steel, ferrite stainless steel, nickel, a nickel alloy, titanium, and a titanium alloy.
